(19) United States
(12) Patent Application Publication
(10) Pub. No.: US 2026/0197812 A1
(43) Pub. Date: Jul. 9, 2026

(54) BEAM INDICATION METHOD AND APPARATUS, DEVICE, AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 19/133,761

(22) PCT Filed: Dec. 6, 2022
(86) PCT No.: PCT/CN2022/137038

§ 371 Date: May 29, 2025

(51) Int. Cl. H04W 72/044

(52) U.S. Cl. CPC H04W 72/046

(57) ABSTRACT

The present disclosure relates to a beam indication method and apparatus, a device, and a storage medium. The method includes: receiving beam indication information sent by a network device, the beam indication information comprising a quasi co-location (QCL) Type D. The QCL Type D is used to indicate at least one of the following information: a reference signal identifier, and receiving beam information of a target receiving beam.

### CROSS-REFERENCE TO RELATED APPLICATIONS

The present application is a U.S. National Stage of International Application No. PCT/CN2022/137038, filed on Dec. 6, 2022, the contents of which are incorporated herein by reference in its entirety for all purposes.

### TECHNICAL FIELD

The present disclosure relates to the field of communication technologies, and in particular to a method and apparatus and device for indicating a beam, and a storage medium.

### BACKGROUND

In New Radio (NR), especially when a communication frequency band is in frequency range 2, due to the rapid attenuation of high-frequency channels, beam-based transmission and reception are required to ensure coverage.

In some beam management procedures, a network device will configure a reference signal resource set for beam measurement. A terminal measures reference signal resources in the reference signal resource set, and the terminal reports identities (IDs) of some stronger reference signal resources and the corresponding layer 1 reference signal received powers (L1-RSRPs) and/or layer 1 signal to interference plus noise ratios (L1-SINRs) to the network device.

In a current traditional method, the reference signal resource set configured by the network device includes X reference signals, and each reference signal corresponds to a different transmit beam of the network device. For each reference signal, the terminal needs to measure all receive beams for the reference signal. Therefore, the number of beam pairs that the terminal needs to measure is M*N, where M represents the number of transmit beams of the network device, and N is the number of receive beams of the terminal.

In some cases, in order to reduce the number of beam pairs measured by the terminal, an artificial intelligence (AI) model can be used for beam prediction.

### SUMMARY

The present disclosure provides a method and apparatus and device for indicating a beam, and a storage medium.

According to a first aspect of embodiments of the present disclosure, there is provided a method for indicating a beam, which is applied to a terminal. The method includes: receiving beam indication information sent by a network device, wherein the beam indication information includes a quasico-location (QCL) type D, and the QCL type D is configured to indicate at least one of: a reference signal identifier; or receive beam information of a target receive beam.

According to a second aspect of embodiments of the present disclosure, there is provided a method for indicating a beam, which is applied to a network device. The method includes: sending beam indication information to a terminal, wherein the beam indication information includes a quasico-location (QCL) type D, and the QCL type D is configured to indicate at least one of: a reference signal identifier; or receive beam information of a target receive beam.

According to a third aspect of embodiments of the present disclosure, there is provided a device for indicating a beam, including: a processor; and a memory configured to store executable instructions of the processor; wherein the processor is configured to execute the method involved in the first aspect.

According to a fourth aspect of embodiments of the present disclosure, there is provided a device for indicating a beam, including: a processor; and a memory configured to store executable instructions of the processor; wherein the processor is configured to execute the method involved in the second aspect.

According to a fifth aspect of an embodiment of the present disclosure, there is provided a non-transitory computer-readable storage medium, wherein instructions in the storage medium, when executed by a processor of a terminal, enable the terminal to execute the method involved in the first aspect.

According to a sixth aspect of an embodiment of the present disclosure, there is provided a non-transitory computer-readable storage medium, wherein instructions in the storage medium, when executed by a processor of a network device, enable the network device to execute the method involved in the second aspect.

It should be noted that the above general description and the following detailed description are merely exemplary and explanatory and should not be construed as limiting of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain principles of the present disclosure.

FIG. 1 shows a schematic diagram of a wireless communication system according to an embodiment of the present disclosure.

FIG. 2 shows a flowchart of a method for indicating a beam according to an embodiment of the present disclosure.

FIG. 3 shows a flowchart of another method for indicating a beam according to an embodiment of the present disclosure.

FIG. 4 shows a flowchart of yet another method for indicating a beam according to an embodiment of the present disclosure.

FIG. 5 shows a flowchart of still another method for indicating a beam according to an embodiment of the present disclosure.

FIG. 6 shows a flowchart of another method for indicating a beam according to an embodiment of the present disclosure.

FIG. 7 shows a schematic diagram of an apparatus for indicating a beam according to an embodiment of the present disclosure.

FIG. 8 shows a schematic diagram of another apparatus for indicating a beam according to an embodiment of the present disclosure.

FIG. 9 shows a schematic diagram of a device for indicating a beam according to an embodiment of the present disclosure.

FIG. 10 shows a schematic diagram of another device for indicating a beam according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. Implementations set forth in the following description of the embodiments do not represent all implementations consistent with embodiments of the present disclosure.

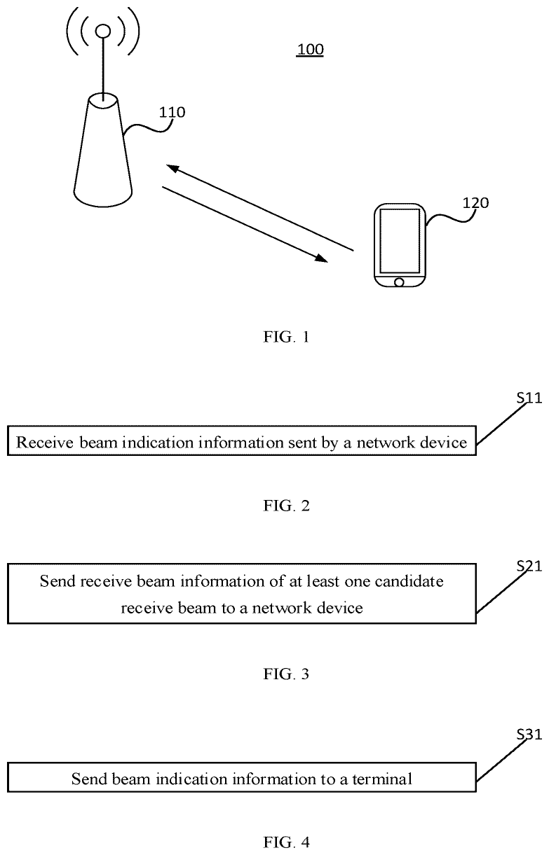

A communication method involved in the present disclosure can be applied to a wireless communication system 100 shown in FIG. 1. The network system may include a network device 110 and a terminal 120. It can be understood that the wireless communication system shown in FIG. 1 is only illustrative and may also include other network devices, for example, core network devices, radio relay devices, radio backhaul devices, etc., which are not depicted in FIG. 1. Embodiments of the present disclosure do not limit the number of network devices and the number of terminals included in the wireless communication system.

It can be further understood that the wireless communication system according to embodiments of the present disclosure is a network providing a wireless communication function. The wireless communication system may use different communication technologies, for example, Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), and Carrier Sense Multiple Access with Collision Avoidance. Networks may be classified into 2nd generation (2G) networks, 3G networks, 4G networks, or future evolved networks, for example, 5th Generation Wireless Communication System (5G) networks according to factors of capacity, rate, latency, etc. of different networks. The 5G networks may also be referred to as new radio (NR) networks. For convenience of description, the present disclosure sometimes refers to a wireless communication network simply as a network.

Further, the network device 110 involved in the present disclosure may also be referred to as a radio access network device. The radio access network device may be a base station, an evolved Node B (eNB), a home base station, a radio relay node, a radio backhaul node, a transmission point (TP), a transmission and receiving point (TPR) or an access point (AP) in a Wireless Fidelity (WIFI) system, etc., or may be a gNB in an NR system, or may be a component or some of devices constituting a base station, etc. When the wireless communication system is a vehicle-to-everything (V2X) communication system, the network device may also be a vehicle-mounted device. It is to be understood that embodiments of the present disclosure do not limit a particular technology and a particular device configuration used by the network device.

Further, the terminal 120 involved in the present disclosure may also be referred to as a terminal device, a user equipment (UE), a mobile station (MS), a mobile terminal (MT), etc., and is a device that provides a user with speech and/or data connectivity. For example, the terminal may be a handheld device, a vehicle-mounted device, etc. which has a radio connection function. Some instances of the terminal include a mobile phone, a pocket personal computer (PPC), a palmtop computer, a personal digital assistant (PDA), a laptop computer, a tablet computer, a wearable device, a vehicle-mounted device, etc. Moreover, when the wireless communication system is the vehicle-to-everything (V2X) communication system, the terminal device may also be a vehicle-mounted device. It is to be understood that embodiments of the present disclosure do not limit a particular technology and a particular device configuration used by the terminal.

In embodiments of the present disclosure, the network device 110 and the terminal 120 may use any feasible wireless communication technology to achieve mutual data transmission. A transmission channel corresponding to the network device 110 sending data or control information to the terminal 120 is called a downlink channel (DL), and a transmission channel corresponding to the terminal 120 sending data or control information to the network device 110 is called an uplink channel (UL). It can be understood that the network device involved in embodiments of the present disclosure may be a base station. Alternatively, the network device may also be any other possible network device, and the terminal may be any possible terminal, which is not limited by the present disclosure.

In the NR, especially when a communication frequency band is in frequency range 2, due to the rapid attenuation of high-frequency channels, beam-based transmission and reception are required to ensure coverage.

In a conventional beam management procedure, a network device will configure a reference signal resource set for beam measurement. A terminal measures reference signal resources in the reference signal resource set, and the terminal reports identities (IDs) of some stronger reference signal resources and the corresponding L1-RSRPs and/or L1-SINR to the network device.

In a current traditional method, the reference signal resource set configured by the network device includes X reference signals, and each reference signal corresponds to a different transmit beam of the network device. For at least one reference signal, the terminal needs to measure all receive beams for the reference signal, so as to obtain beam measurement qualities corresponding to all receive beams, respectively. In some cases, one or more best beam measurement qualities and/or beam identities corresponding to the best beam measurement qualities can be determined. Therefore, the maximum number of beam pairs that the terminal needs to measure is M*N, where M represents the number of transmit beams of the network device, and N is the number of receive beams of the terminal.

In addition, if the periodic beam measurement reporting is configured, the terminal also needs to perform measurement for a reference signal of each period and report the measured beam measurement quality.

In some cases, in order to reduce the number of beam pairs measured by the terminal, an artificial intelligence (AI) model can be used for beam prediction. For example, the beam can be predicted to determine the preferred beam. It can be understood that the preferred beam can be a preferred transmit beam, a preferred receive beam, or a preferred beam pair, where the preferred beam pair is a beam pair consisting of the preferred transmit beam and the preferred receive beam. The preferred beam may be a beam predicted by the AI model whose beam quality meets conditions. For downlink, a transmit beam of a network device and a receive beam of a terminal may constitute a beam pair. Then, when the AI model for predicting the beam is running on the network device, among the preferred beams determined by the network device based on an output of the AI model, the preferred transmit beam or the preferred transmit beam in the preferred beam pair may not have been measured by the terminal, or may have been measured by the terminal, but not measured based on the preferred receive beam. In this case. If the network device performs channel/signal transmission based on the preferred transmit beam, and only indicates, based on the traditional beam indication method, the reference signal identifier corresponding to the transmit beam to the terminal, the terminal may not know which receive beam to use for reception.

In the related arts, in general, the network device sends a reference signal, and then the terminal performs measurement and reporting. For example, for reference signal (RS) #1, the terminal will use a plurality of receive (Rx) beams configured by its own device, and report the L1-RSRP and/or L1-SINR corresponding to performing the reception through the best Rx beam, as well as the ID of the RS to the network device. The terminal will save the best Rx beam corresponding to RS #1. Then, if the network device needs to, based on the transmit beam of RS #1, transmit the data/signal on a channel next, the network device can use a transmission configuration indication (TCI) state or spatial relationship information (spatialrelationinfo) to indicate the RS ID, and the terminal will perform reception based on the stored best Rx beam corresponding to the RS ID.

However, at present, since the network device is based on the RS corresponding to the preferred beam predicted by the AI model, and the terminal does not know which best Rx beam corresponds to the RS, how the network device indicates the preferred beam to the terminal is a problem that needs to be solved.

Therefore, in the present disclosure, the network device indicates the relevant information of the receive beam to the terminal, so that the terminal can use the corresponding receive beam to receive the data/signal sent by the network device, thereby improving the communication efficiency. In addition, the reference signal overhead caused by beam prediction can be reduced.

FIG. 2 shows a flowchart of a method for indicating a beam according to an embodiment of the present disclosure. As shown in FIG. 2, the method is applied to a terminal and may include the following step:

In step S11, beam indication information sent by a network device is received.

In some embodiments, the terminal may receive the beam indication information sent by the network device. The beam indication information may include quasico-location (QCL) type D, and the QCL type D is configured to indicate at least one of: a reference signal identifier; or receive beam information of a target receive beam.

In some embodiments, the QCL type D may be configured to indicate the reference signal identifier. The identifier may be an ID or an index. It can be understood that the reference signal identifier can be used to implicitly indicate to the terminal the transmit beam for transmitting the reference signal. That is, the reference signal identifier indicates the corresponding reference signal, and the network device will use the same transmit beam as the transmit beam when sending the reference signal, to send the data or the signal. Then, accordingly, the terminal can use the same receive beam as the receive beam when receiving the reference signal, to receive the data or the signal.

In some embodiments, the QCL type D may be configured to indicate the receive beam information of the target receive beam. The target receive beam can be considered as a receive beam used by the terminal to receive a reference signal sent by the network device. Alternatively, the target receive beam can also be considered as a receive beam in a preferred beam predicted by the network device based on a beam prediction model. For example, the target receive beam can be the preferred receive beam, or the preferred receive beam in the preferred beam pair.

It can be understood that the beam prediction model involved in the present disclosure can be the AI model mentioned above.

The terminal may receive, based on the target receive beam indicated by the beam indication information sent by the network device, the data/signal sent by the network device corresponding to the beam indication information. The beam indication information is configured to indicate the target receive beam corresponding to the terminal receiving the data/signal sent by the network device.

In some embodiments, the QCL type D may be configured to indicate the reference signal identifier, and the QCL type D may also indicate the receive beam information of the target receive beam.

In some embodiments, after S11, a step in which the terminal receives the data/signal sent by the network device may also be included.

In some embodiments, after S11, a step in which the terminal sends the data/signal to the network device may also be included.

It can be understood that the beam indication information can be configured to indicate relevant information when the terminal receives the data/signal. The data/signal may include data or control information transmitted on one or more of a physical downlink control channel (PDCCH), a physical downlink shared channel (PDSCH), a physical uplink control channel (PUCCH), and a physical uplink shared channel (PUSCH), as well as a channel state information-reference signal (CSI-RS), a sounding reference signal (SRS), etc.

In the present disclosure, the network device indicates the relevant information of the receive beam to the terminal, so that the terminal can use the corresponding receive beam to receive the data/signal sent by the network device, thereby improving the communication efficiency. In addition, the reference signal overhead caused by the beam prediction can be reduced.

In the method for indicating the beam provided by embodiments of the present disclosure, the reference signal identifier includes at least one of: a synchronization signal block (SSB) identifier, a CSI-RS identifier, or an SRS identifier.

In some embodiments, the reference signal identifier may be the SSB identifier. The SSB identifier may be used to indicate the corresponding SSB, and the terminal may assume that the data/signal sent by the network device has the same QCL Type D assumption or the same spatial relationship information as the SSB. The terminal may also assume that the data/signal sent to the network device has the same QCL Type D assumption or the same spatial relationship information as the SSB. That is, the terminal can receive, on the receive beam corresponding to the SSB, the data/signal sent by the network device, or send the data/signal to the network device on the transmit beam corresponding to the SSB.

In some embodiments, the reference signal identifier may be the CSI-RS identifier. The CSI-RS identifier may be used to indicate the corresponding CSI-RS, and the terminal may assume that the data/signal sent by the network device has the same QCL Type D assumption or the same spatial relationship information as the CSI-RS. The terminal may also assume that the data/signal sent to the network device has the same QCL Type D assumption or the same spatial relationship information as the CSI-RS. That is, the terminal may receive, on the receive beam corresponding to the CSI-RS, the data/signal sent by the network device, or send the data/signal to the network device on the transmit beam corresponding to the CSI-RS.

In some embodiments, the reference signal identifier may be the SRS identifier. The SRS identifier may be used to indicate the corresponding SRS, and the terminal may assume that the data/signal sent to the network device has the same QCL Type D assumption or the same spatial relationship information as the SRS. That is, the terminal may send the data/signal to the network device on the transmit beam corresponding to the SRS.

In some embodiments, the reference signal identifier may be the SSB identifier and the CSI-RS identifier. The SSB identifier may be used to indicate the corresponding SSB, and the CSI-RS identifier may be used to indicate the corresponding CSI-RS. The terminal may assume that the data/signal sent by the network device has the same QCL Type D assumption or the same spatial relationship information as the SSB or CSI-RS. The terminal may also assume that the data/signal sent to the network device has the same QCL Type D assumption or the same spatial relationship information as the SSB or CSI-RS. That is, the terminal may receive, on the receive beam corresponding to the SSB or CSI-RS, the data/signal sent by the network device, or send the data/signal to the network device on the transmit beam corresponding to the SSB or CSI-RS.

In some embodiments, the reference signal identifier may be the SSB identifier and the SRS identifier. The SSB identifier may be used to indicate the corresponding SSB, and the SRS identifier may be used to indicate the corresponding SRS. The terminal may assume that the data/signal sent by the network device has the same QCL Type D assumption or the same spatial relationship information as the SSB. The terminal may also assume that the data/signal sent to the network device has the same QCL Type D assumption or the same spatial relationship information as the SSB or SRS. That is, the terminal may receive, on the receive beam corresponding to the SSB, the data/signal sent by the network device, or send the data/signal to the network device on the transmit beam corresponding to the SSB or SRS.

In some embodiments, the reference signal identifier may be the CSI-RS identifier and the SRS identifier. The CSI-RS identifier may be used to indicate the corresponding CSI-RS, and the SRS identifier may be used to indicate the corresponding SRS. The terminal may assume that the data/signal sent by the network device has the same QCL Type D assumption or the same spatial relationship information as the CSI-RS. The terminal may also assume that the data/signal sent to the network device has the same QCL Type D assumption or the same spatial relationship information as the CSI-RS or SRS. That is, the terminal may receive, on the receive beam corresponding to the CSI-RS, the data/signal sent by the network device, or send the data/signal to the network device on the transmit beam corresponding to the CSI-RS or SRS.

In some embodiments, the reference signal identifier may be the SSB identifier, the CSI-RS identifier, and the SRS identifier. The SSB identifier may be used to indicate the corresponding SSB, the CSI-RS identifier may be used to indicate the corresponding CSI-RS, and the SRS identifier may be used to indicate the corresponding SRS. The terminal may assume that the data/signal sent by the network device has the same QCL Type D assumption or the same spatial relationship information as the SSB or CSI-RS. The terminal may also assume that the data/signal sent to the network device has the same QCL Type D assumption or the same spatial relationship information as the SSB, CSI-RS, or SRS. That is, the terminal may receive, on the receive beam corresponding to the SSB or CSI-RS, the data/signal sent by the network device, or send the data/signal to the network device on the transmit beam corresponding to the SSB, CSI-RS, or SRS.

The present disclosure provides a variety of different reference signal identifier types to be applicable to different reference signal scenarios. Accordingly, in the corresponding scenario, the network device can indicate the relevant information of the receive beam to the terminal, and the terminal can use the corresponding receive beam to receive the data/signal sent by the network device, thereby improving the communication efficiency. In addition, the reference signal overhead caused by beam prediction can be reduced.

In the method for indicating the beam provided by embodiments of the present disclosure, the beam indication information is transmission configuration indication (TCI) state configuration information and/or spatial relationship configuration information.

In some embodiments, the beam indication information may be the TCI state configuration information. The TCI state configuration information may configure a TCI state, and the TCI state may include at least one of a joint TCI state, a DL TCI state or a UL TCI state. It can be understood that the joint TCI state can be used for both the uplink transmission and the downlink transmission.

In some embodiments, the beam indication information may be the spatialrelationinfo configuration information.

In some embodiments, the beam indication information may be the TCI state configuration information and the spatialrelationinfo configuration information.

It can be understood that the network device can indicate the QCL type D through the TCI state configuration information and/or the spatialrelationinfo configuration information, thereby realizing the indication of the beam.

In the present disclosure, the network device can indicate the relevant information of the receive beam to the terminal through various types of beam indication information, and the terminal can use the corresponding receive beam to receive the data/signal sent by the network device, thereby improving the communication efficiency. In addition, the reference signal overhead caused by beam prediction can be reduced.

In the method for indicating the beam provided by embodiment of the present disclosure, FIG. 3 shows a flowchart of another method for indicating a beam according to an embodiment of the present disclosure. As shown in FIG. 3, the method may further include the following step:

in step S21, receive beam information of at least one candidate receive beam is sent to the network device.

In some embodiments, the terminal may send the receive beam information of the at least one candidate receive beam to the network device. It can be understood that, considering that the beam prediction model can be trained on the network device, the terminal may send the receive beam information of the at least one candidate beam to the network device, so that the network device obtains the receive beam information of the target receive beam based on the receive beam information of the at least one candidate beam.

In some embodiments, the receive beam information of the at least one candidate receive beam may be carried in at least one of: a data sample for beam prediction model training; a beam report for an input of a beam prediction model; auxiliary information related to the beam prediction model; data for beam prediction model monitoring; or a data sample for beam prediction model fine-tuning.

For example, the receive beam information of the at least one candidate receive beam may be carried in the data sample for beam prediction model training.

For another example, the receive beam information of the at least one candidate receive beam may be carried in the beam report for the input of the beam prediction model.

For another example, the receive beam information of the at least one candidate receive beam may be carried in the auxiliary information related to the beam prediction model.

For another example, the receive beam information of the at least one candidate receive beam may be carried in the data for beam prediction model monitoring.

For another example, the receive beam information of the at least one candidate receive beam may be carried in the data sample for beam prediction model fine-tuning.

Alternatively, the receive beam information of the at least one candidate receive beam can also be carried in any two, three, four or five of the above-mentioned information, such as the data sample for beam prediction model training and the beam report for the input of the beam prediction model; or the data sample for beam prediction model training and the auxiliary information related to the beam prediction model; or the data sample for beam prediction model training, the data for beam prediction model monitoring and the data sample for beam prediction model fine-tuning; or the data sample for beam prediction model training, the beam report for the input of the beam prediction model, the auxiliary information related to the beam prediction model, and the data sample for beam prediction model fine-tuning; or the data sample for beam prediction model training, the beam report for the input of the beam prediction model, the auxiliary information related to the beam prediction model, the data for beam prediction model monitoring and the data sample for beam prediction model fine-tuning, etc., which are no longer listed one by one in the present disclosure.

In the present disclosure, the terminal can send the receive beam information of the at least one candidate receive beam to the network device, so that the network device determines the target receive beam based on the receive beam information of the candidate receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

In the method for indicating the beam provided by embodiments of the present disclosure, the receive beam information includes at least one of: a receive beam identifier; a receive beam boresight direction; a receive beam angle; a receive beam width; a receive beam shape; or a receive beam codebook type.

In some embodiments, the receive beam information may include an Rx beam identifier, and the Rx beam identifier may be an Rx beam ID or an Rx beam index.

In some embodiments, the receive beam information may include an Rx beam boresight direction.

In some embodiments, the receive beam information may include an Rx beam angle.

In some embodiments, the receive beam information may include an Rx beam width.

In some embodiments, the receive beam information may include an Rx beam shape.

In some embodiments, the receive beam information may include an Rx beam codebook type.

Alternatively, the receive beam information may also include any two, three, four, five or six of the above-mentioned information. For example, the receive beam information may also include the Rx beam identifier and the Rx beam boresight direction; or include the Rx beam identifier and the Rx beam codebook type; or include the Rx beam identifier and the Rx beam angle; or include the Rx beam identifier, the Rx beam boresight direction, and the Rx beam width; or include the Rx beam identifier, the Rx beam angle, and the Rx beam width; or include the Rx beam identifier, the Rx beam boresight direction, and the Rx beam codebook type; or include the Rx beam identifier, the Rx beam boresight direction, the Rx beam angle, and the Rx beam codebook type; or include the Rx beam identifier, the Rx beam boresight direction, the Rx beam angle, the Rx beam width, and the Rx beam codebook type; or include the Rx beam identifier, the Rx beam boresight direction, the Rx beam angle, the Rx beam width, the Rx beam shape, and the Rx beam codebook type, etc., which are not listed one by one in the present disclosure.

The present disclosure provides a variety of information that can be included in the receive beam, so that the network device indicates the relevant information of the receive beam to the terminal, and the terminal can use the corresponding receive beam to receive the data/signal sent by the network device, thereby improving the communication efficiency. In addition, the reference signal overhead caused by beam prediction can be reduced.

In the method for indicating the beam provided by embodiments of the present disclosure, in response to the beam prediction model running on the network device, the target receive beam is determined by the network device based on the beam prediction model.

In some embodiments, in response to the beam prediction model running on the network device, the target receive beam may be determined by the network device based on the beam prediction model. That is, the network device may predict the target receive beam through the beam prediction model.

For example, assuming that the beam prediction model runs on the network device, the network device can use the received at least one candidate receive beam to determine the target receive beam. For example, the network device uses the at least one candidate receive beam as the input of the beam prediction model to obtain the target receive beam output by the beam prediction model. Alternatively, the beam prediction model can be pre-trained or trained by the network device using data samples for model training, which is not limited in the present disclosure.

For example, the beam prediction model running on the network device can output a preferred beam. The preferred beam can be a preferred transmit beam, a preferred receive beam and/or a preferred beam pair, where the preferred beam pair includes the preferred transmit beam and the preferred receive beam. The network device can use the preferred receive beam or the preferred receive beam in the preferred beam pair as the target receive beam. That is, when the network device uses the preferred transmit beam or the preferred transmit beam in the preferred beam pair to send the reference signal, the receive beam corresponding to the maximum L1-RSRP/L1-SINR obtained by the terminal when receiving the reference signal is the preferred receive beam. The network device can use the preferred transmit beam or the preferred transmit beam in the preferred beam pair to send the data/signal, and the terminal can use the target receive beam (i.e., the preferred receive beam) to receive the data/signal sent by the network device.

In the present disclosure, the network device can determine the target receive beam through the beam prediction model, and the network device indicates the relevant information of the target receive beam to the terminal, the terminal can use the target receive beam to receive the data/signal sent by the network device, thereby improving the communication efficiency. In addition, the reference signal overhead caused by beam prediction can be reduced.

In the method for indicating the beam provided by embodiments of the present disclosure, the receive beam information of the at least one candidate receive beam is carried by at least one of: a radio resource control (RRC) signaling, a medium access control control element (MAC CE) signaling or uplink control information (UCI).

In some embodiments, the receive beam information of the at least one candidate receive beam may be carried by the radio resource control (RRC) signaling.

In some embodiments, the receive beam information of the at least one candidate receive beam may be carried by the medium access control control element (MAC CE) signaling.

In some embodiments, the receive beam information of the at least one candidate receive beam may be carried by the uplink control information (UCI).

Alternatively, in some embodiments, the receive beam information of the at least one candidate receive beam may be carried by the RRC signaling and the MAC CE signaling.

In some embodiments, the receive beam information of the at least one candidate receive beam may be carried by the RRC signaling and the UCI.

In some embodiments, the receive beam information of the at least one candidate receive beam may be carried by the MAC CE signaling and the UCI.

In some embodiments, the receive beam information of the at least one candidate receive beam may be carried by the RRC signaling, the MAC CE signaling and the UCI.

In some embodiments, the above-mentioned RRC signaling, MAC CE signaling and/or UCI may be sent through a physical uplink shared channel (PUSCH) or a physical uplink control channel (PUCCH).

For example, the above-mentioned RRC signaling, MAC CE signaling and/or UCI may be transmitted through channel state information (CSI) reporting information.

The present disclosure provides a variety of ways to carry the receive beam information of the candidate receive beam, so that the terminal can send the receive beam information of the candidate receive beam to the network device. Accordingly, the network device determines the target receive beam based on the receive beam information of the candidate receive beam, and the terminal can use the target receive beam to receive the data/signal sent by the network device, thereby improving the communication efficiency. In addition, the reference signal overhead caused by beam prediction can be reduced.

In the method for indicating the beam provided by embodiments of the present disclosure, the at least one candidate receive beam includes the target receive beam.

In an embodiment, the at least one candidate receive beam may include the target receive beam. That is, the target receive beam determined by the network device may be a receive beam among the at least one candidate receive beam.

In the present disclosure, the at least one candidate receive beam determined by the terminal may include the target receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

Based on the same concept, the present disclosure further provides a method for indicating a beam, which is applied to a network device.

FIG. 4 shows a flowchart of yet another method for indicating a beam according to an embodiment of the present disclosure. As shown in FIG. 4, the method is applied to a network device and may include the following step:

in step S31, beam indication information is sent to a terminal.

In some embodiments, the network device may send the beam indication information to the terminal. The beam indication information may include a QCL type D, and the QCL type D may be configured to indicate at least one of: a reference signal identifier, or receive beam information of a target receive beam.

In some embodiments, the QCL type D may be configured to indicate the reference signal identifier. The identifier may be an ID or an index. It can be understood that the reference signal identifier can be used to implicitly indicate to the terminal the transmit beam for transmitting the reference signal. That is, the reference signal identifier indicates the corresponding reference signal, and the network device will use the same transmit beam as the transmit beam when sending the reference signal, to send the data or the signal. Then, accordingly, the terminal can use the same receive beam as the receive beam when receiving the reference signal, to receive the data or the signal.

In some embodiments, the QCL type D may be configured to indicate the receive beam information of the target receive beam. The target receive beam can be considered as a receive beam used by the terminal to receive a reference signal sent by the network device. Alternatively, the target receive beam can also be considered as a receive beam in a preferred beam predicted by the network device based on a beam prediction model. For example, the target receive beam can be the preferred receive beam, or the preferred receive beam in the preferred beam pair.

It can be understood that the beam prediction model involved in the present disclosure can be the AI model mentioned above.

The network device may send the beam indication information to the terminal to indicate the target receive beam. The network device may also send the data/signal corresponding to the beam indication information to the terminal. The beam indication information is configured to indicate the corresponding target receive beam when the terminal receives the data/signal sent by the network device.

In some embodiments, the QCL type D may be configured to indicate the reference signal identifier, and the QCL type D may also indicate the receive beam information of the target receive beam.

In some embodiments, after S31, a step in which the network device sends the data/signal to the terminal may also be included.

In some embodiments, after S31, a step in which the network device receives the data/signal sent by the terminal may also be included.

It can be understood that the beam indication information can be configured to indicate the relevant information when the terminal receives the data/signal sent by the network device. The data/signal may include data or control information transmitted on one or more of a PDCCH, a PDSCH, a PUCCH, or a PUSCH, as well as a CSI-RS, a SRS, etc.

In the present disclosure, the network device indicates the relevant information of the receive beam to the terminal, so that the terminal can use the corresponding receive beam to receive the data/signal sent by the network device, thereby improving the communication efficiency. In addition, the reference signal overhead caused by the beam prediction can be reduced.

In the method for indicating the beam provided by embodiments of the present disclosure, the reference signal identifier includes at least one of: a synchronization signal block (SSB) identifier, a channel state information-reference signal (CSI-RS) identifier, or a sounding reference signal (SRS) identifier.

In some embodiments, the reference signal identifier may be the SSB identifier. The SSB identifier may be used to indicate the corresponding SSB. The network device may assume that the data/signal sent by the terminal has the same QCL Type D assumption or the same spatial relationship information as the SSB. The network device may also assume that the data/signal sent to the terminal has the same QCL Type D assumption or the same spatial relationship information as the SSB. That is, the network device may send the data/signal to the terminal on the transmit beam corresponding to the SSB, or receive, on the receive beam corresponding to the SSB, the data/signal sent by the terminal.

In some embodiments, the reference signal identifier may be the CSI-RS identifier. The CSI-RS identifier may be used to indicate the corresponding CSI-RS. The network device may assume that the data/signal sent by the terminal has the same QCL Type D assumption or the same spatial relationship information as the CSI-RS. The network device may also assume that the data/signal sent to the terminal has the same QCL Type D assumption or the same spatial relationship information as the CSI-RS. That is, the network device may send the data/signal to the terminal on the transmit beam corresponding to the CSI-RS, or receive, on the receive beam corresponding to the CSI-RS, the data/signal sent by the terminal.

In some embodiments, the reference signal identifier may be the SRS identifier. The SRS identifier may be used to indicate the corresponding SRS. The network device may assume that the data/signal sent by the terminal has the same QCL Type D assumption or the same spatial relationship information as the SRS. The network device may receive, on the receive beam corresponding to the SRS, the data/signal sent by the terminal.

In some embodiments, the reference signal identifier may be the SSB identifier and the CSI-RS identifier. The SSB identifier may be used to indicate the corresponding SSB, and the CSI-RS identifier may be used to indicate the corresponding CSI-RS. The network device may assume that the data/signal sent by the terminal has the same QCL Type D assumption or the same spatial relationship information as the SSB or CSI-RS. The network device may also assume that the data/signal sent to the terminal has the same QCL Type D assumption or the same spatial relationship information as the SSB or CSI-RS. That is, the network device may send the data/signal to the terminal on the transmit beam corresponding to the SSB or CSI-RS, or receive, on the receive beam corresponding to the SSB or CSI-RS, the data/signal sent by the terminal.

In some embodiments, the reference signal identifier may be the SSB identifier and the SRS identifier. The SSB identifier may be used to indicate the corresponding SSB, and the SRS identifier may be used to indicate the corresponding SRS. The network device may assume that the data/signal sent by the terminal has the same QCL Type D assumption or the same spatial relationship information as the SSB or SRS. The network device may also assume that the data/signal sent to the terminal has the same QCL Type D assumption or the same spatial relationship information as the SSB. That is, the network device may send the data/signal to the terminal on the transmit beam corresponding to the SSB, or receive, on the receive beam corresponding to the SSB or SRS, the data/signal sent by the terminal.

In some embodiments, the reference signal identifier may be the CSI-RS identifier and the SRS identifier. The CSI-RS identifier may be used to indicate the corresponding CSI-RS, and the SRS identifier may be used to indicate the corresponding SRS. The network device may assume that the data/signal sent by the terminal has the same QCL Type D assumption or the same spatial relationship information as the CSI-RS or SRS. The network device may also assume that the data/signal sent to the terminal has the same QCL Type D assumption or the same spatial relationship information as the CSI-RS. That is, the network device may send the data/signal to the terminal on the transmit beam corresponding to the CSI-RS, or receive, on the receive beam corresponding to the CSI-RS or SRS, the data/signal sent by the terminal.

In some embodiments, the reference signal identifier may be the SSB identifier, the CSI-RS identifier, and the SRS identifier. The SSB identifier may be used to indicate the corresponding SSB, the CSI-RS identifier may be used to indicate the corresponding CSI-RS, and the SRS identifier may be used to indicate the corresponding SRS. The network device may assume that the data/signal sent by the terminal has the same QCL Type D assumption or the same spatial relationship information as the SSB, CSI-RS, or SRS. The network device may also assume that the data/signal sent to the terminal has the same QCL Type D assumption or the same spatial relationship information as the SSB or CSI-RS. That is, the network device may send the data/signal to the terminal on the transmit beam corresponding to the SSB or CSI-RS, or receive, on the receive beam corresponding to the SSB, CSI-RS, or SRS, the data/signal sent by the terminal.

The present disclosure provides a variety of different reference signal identifier types to be applicable to different reference signal scenarios. Accordingly, in the corresponding scenario, the network device can indicate the relevant information of the receive beam to the terminal, and the terminal can use the corresponding receive beam to receive the data/signal sent by the network device, thereby improving the communication efficiency. In addition, the reference signal overhead caused by beam prediction can be reduced.

In the method for indicating the beam provided by embodiments of the present disclosure, the beam indication information is transmission configuration indication (TCI) state configuration information and/or spatial relationship configuration information.

In some embodiments, the beam indication information may be the TCI state configuration information. The TCI state configuration information may configure a TCI state, and the TCI state may include at least one of a joint TCI state, a DL TCI state or a UL TCI state. It can be understood that the joint TCI state can be used for both the uplink transmission and the downlink transmission.

In some embodiments, the beam indication information may be the spatialrelationinfo configuration information.

In some embodiments, the beam indication information may be the TCI state configuration information and the spatialrelationinfo configuration information.

It can be understood that the network device can indicate the QCL type D through the TCI state configuration information and/or the spatialrelationinfo configuration information, thereby realizing the indication of the beam.

In the present disclosure, the network device can indicate the relevant information of the receive beam to the terminal through various types of beam indication information, and the terminal can use the corresponding receive beam to receive the data/signal sent by the network device, thereby improving the communication efficiency. In addition, the reference signal overhead caused by beam prediction can be reduced.

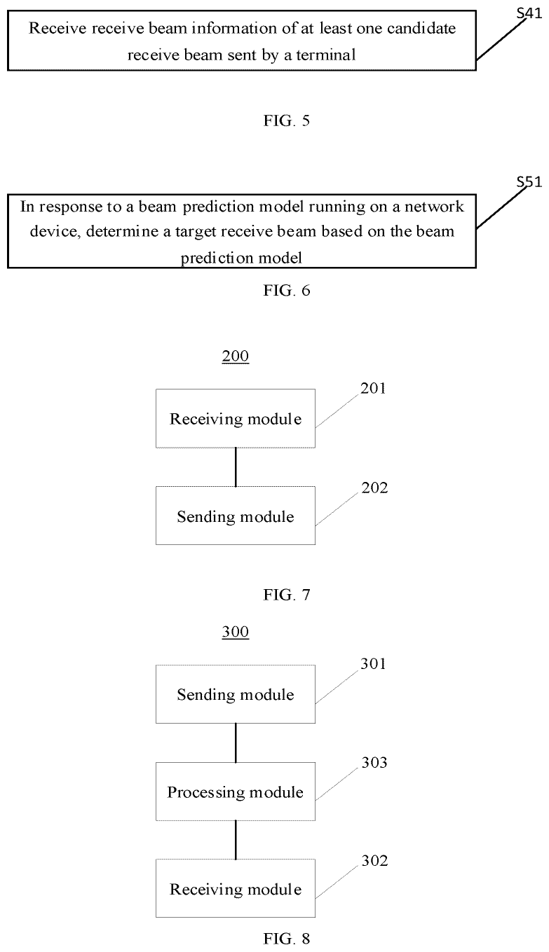

In the method for indicating the beam provided by embodiments of the present disclosure, FIG. 5 shows a flowchart of still another method for indicating a beam according to an embodiment of the present disclosure. As shown in FIG. 5, the method may further include the following step:

in step S41, receive beam information of at least one candidate receive beam sent by the terminal is received.

In some embodiments, the network device may receive the receive beam information of the at least one candidate receive beam sent by the terminal, so that the network device may obtain the receive beam information of the target receive beam based on the receive beam information of the at least one candidate beam.

In some embodiments, the receive beam information of the at least one candidate receive beam may be carried in at least one of: a data sample for beam prediction model training; a beam report for an input of a beam prediction model; auxiliary information related to the beam prediction model; data for beam prediction model monitoring; or a data sample for beam prediction model fine-tuning.

For example, the receive beam information of the at least one candidate receive beam may be carried in the data sample for beam prediction model training.

For another example, the receive beam information of the at least one candidate receive beam may be carried in the beam report for the input of the beam prediction model.

For another example, the receive beam information of the at least one candidate receive beam may be carried in the auxiliary information related to the beam prediction model.

For another example, the receive beam information of the at least one candidate receive beam may be carried in the data for beam prediction model monitoring.

For another example, the receive beam information of the at least one candidate receive beam may be carried in the data sample for beam prediction model fine-tuning.

Alternatively, the receive beam information of the at least one candidate receive beam can also be carried in any two, three, four or five of the above-mentioned information, such as the data sample for beam prediction model training and the beam report for the input of the beam prediction model; or the data sample for beam prediction model training and the auxiliary information related to the beam prediction model; or the data sample for beam prediction model training, the data for beam prediction model monitoring and the data sample for beam prediction model fine-tuning; or the data sample for beam prediction model training, the beam report for the input of the beam prediction model, the auxiliary information related to the beam prediction model, and the data sample for beam prediction model fine-tuning; or the data sample for beam prediction model training, the beam report for the input of the beam prediction model, the auxiliary information related to the beam prediction model, the data for beam prediction model monitoring and the data sample for beam prediction model fine-tuning, etc., which are no longer listed one by one in the present disclosure.

It can be understood that the network device can obtain, by receiving any one or more of the above information, the receive beam information of the at least one candidate receive beam carried in any one or more of the above information.

In the present disclosure, the network device can receive the receive beam information of the at least one candidate receive beam sent by the terminal, so that the network device can determine the target receive beam based on the receive beam information of the candidate receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

In the method for indicating the beam provided by embodiments of the present disclosure, the receive beam information includes at least one of: a receive beam identifier; a receive beam boresight direction; a receive beam angle; a receive beam width; a receive beam shape; or a receive beam codebook type.

In some embodiments, the receive beam information may include an Rx beam identifier, and the Rx beam identifier may be an Rx beam ID or an Rx beam index.

In some embodiments, the receive beam information may include an Rx beam boresight direction.

In some embodiments, the receive beam information may include an Rx beam angle.

In some embodiments, the receive beam information may include an Rx beam width.

In some embodiments, the receive beam information may include an Rx beam shape.

In some embodiments, the receive beam information may include an Rx beam codebook type.

Alternatively, the receive beam information may also include any two, three, four, five or six of the above-mentioned information. For example, the receive beam information may also include the Rx beam identifier and the Rx beam boresight direction; or include the Rx beam identifier and the Rx beam codebook type; or include the Rx beam identifier and the Rx beam angle; or include the Rx beam identifier, the Rx beam boresight direction, and the Rx beam width; or include the Rx beam identifier, the Rx beam angle, and the Rx beam width; or include the Rx beam identifier, the Rx beam boresight direction, and the Rx beam codebook type; or include the Rx beam identifier, the Rx beam boresight direction, the Rx beam angle, and the Rx beam codebook type; or include the Rx beam identifier, the Rx beam boresight direction, the Rx beam angle, the Rx beam width, and the Rx beam codebook type; or include the Rx beam identifier, the Rx beam boresight direction, the Rx beam angle, the Rx beam width, the Rx beam shape, and the Rx beam codebook type, etc., which are not listed one by one in the present disclosure.

The present disclosure provides a variety of information that can be included in the receive beam, so that the network device indicates the relevant information of the receive beam to the terminal, and the terminal can use the corresponding receive beam to receive the data/signal sent by the network device, thereby improving the communication efficiency. In addition, the reference signal overhead caused by beam prediction can be reduced.

In the method for indicating the beam provided by embodiments of the present disclosure, FIG. 6 shows a flowchart of another method for indicating a beam according to an embodiment of the present disclosure. As shown in FIG. 6, the method may further include the following step:

in step S51, in response to a beam prediction model running on the network device, the target receive beam is determined based on the beam prediction model.

In some embodiments, in response to the beam prediction model running on the network device, the network device may determine the target receive beam based on the beam prediction model. That is, the network device may predict the target receive beam through the beam prediction model.

For example, assuming that the beam prediction model runs on the network device, the network device can use the received at least one candidate receive beam to determine the target receive beam. For example, the network device uses the at least one candidate receive beam as the input of the beam prediction model to obtain the target receive beam output by the beam prediction model. Alternatively, the beam prediction model can be pre-trained or trained by the network device using data samples for model training, which is not limited in the present disclosure.

For example, the beam prediction model running on the network device can output a preferred beam. The preferred beam can be a preferred transmit beam, a preferred receive beam and/or a preferred beam pair, where the preferred beam pair includes the preferred transmit beam and the preferred receive beam. The network device can use the preferred receive beam or the preferred receive beam in the preferred beam pair as the target receive beam. That is, when the network device uses the preferred transmit beam or the preferred transmit beam in the preferred beam pair to send the reference signal, the receive beam corresponding to the maximum L1-RSRP/L1-SINR obtained by the terminal when receiving the reference signal is the preferred receive beam. The network device can use the preferred transmit beam or the preferred transmit beam in the preferred beam pair to send the data/signal, and the terminal can use the target receive beam (i.e., the preferred receive beam) to receive the data/signal sent by the network device.

In the present disclosure, the network device can determine the target receive beam through the beam prediction model, and the network device indicates the relevant information of the target receive beam to the terminal, the terminal can use the target receive beam to receive the data/signal sent by the network device, thereby improving the communication efficiency. In addition, the reference signal overhead caused by beam prediction can be reduced.

In the method for indicating the beam provided by embodiments of the present disclosure, the receive beam information of the at least one candidate receive beam is carried by at least one of: a radio resource control (RRC) signaling, a medium access control control element (MAC CE) signaling or uplink control information (UCI).

In some embodiments, the receive beam information of the at least one candidate receive beam may be carried by the RRC signaling.

In some embodiments, the receive beam information of the at least one candidate receive beam may be carried by the MAC CE signaling.

In some embodiments, the receive beam information of the at least one candidate receive beam may be carried by the UCI.

Alternatively, in some embodiments, the receive beam information of the at least one candidate receive beam may be carried by the RRC signaling and the MAC CE signaling.

In some embodiments, the receive beam information of the at least one candidate receive beam may be carried by the RRC signaling and the UCI.

In some embodiments, the receive beam information of the at least one candidate receive beam may be carried by the MAC CE signaling and the UCI.

In some embodiments, the receive beam information of the at least one candidate receive beam may be carried by the RRC signaling, the MAC CE signaling and the UCI.

In some embodiments, the above-mentioned RRC signaling, MAC CE signaling and/or UCI may be sent through a PUSCH or a PUCCH.

For example, the above-mentioned RRC signaling, MAC CE signaling and/or UCI may be transmitted through CSI reporting information.

The present disclosure provides a variety of ways to carry the receive beam information of the candidate receive beam, so that the terminal can send the receive beam information of the candidate receive beam to the network device. Accordingly, the network device determines the target receive beam based on the receive beam information of the candidate receive beam, and the terminal can use the target receive beam to receive the data/signal sent by the network device, thereby improving the communication efficiency. In addition, the reference signal overhead caused by beam prediction can be reduced.

In the method for indicating the beam provided by embodiments of the present disclosure, the at least one candidate receive beam includes the target receive beam.

In an embodiment, the at least one candidate receive beam may include the target receive beam. That is, the target receive beam determined by the network device may be a receive beam among the at least one candidate receive beam.

In the present disclosure, the at least one candidate receive beam determined by the terminal may include the target receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

It should be noted that those skilled in the art can understand that the various implementations/embodiments involved in embodiments of the present disclosure can be used in conjunction with the aforementioned embodiments or can be used independently. Whether used alone or in conjunction with the aforementioned embodiments, the implementation principle is similar. In embodiments of the present disclosure, some embodiments are described in terms of implementation methods used together. Alternatively, those skilled in the art can understand that such examples are not limitations of the embodiments of the present disclosure.

Based on the same concept, embodiments of the present disclosure further provide an apparatus and a device for indicating a beam.

It can be understood that in order to implement the above-mentioned functions, the apparatus and the device for determining the beam provided in embodiments of the present disclosure include corresponding hardware structures and/or software modules for executing respective functions. In combination with units and algorithm steps of various examples disclosed in embodiments of the present disclosure, embodiments of the present disclosure may be implemented by in a form of hardware or a combination of the hardware and computer software. Whether a certain function is implemented in the fashion of hardware or in the fashion that the computer software drives the hardware depends on a particular application and design constraints of the technical solution. A person skilled in the art may implement the described functions with different methods for each particular application, but such an implementation shall not be regarded as going beyond the scope of the technical solution according to embodiments of the present disclosure.

FIG. 7 shows a schematic diagram of an apparatus for indicating a beam according to an embodiment of the present disclosure. Referring to FIG. 7, the apparatus 200 is configured in a terminal, and the apparatus 200 may include: a receiving module 201, configured to receive beam indication information sent by a network device, wherein the beam indication information includes a quasico-location (QCL) type D, and the QCL type D is configured to indicate at least one of: a reference signal identifier; or receive beam information of a target receive beam.

In the present disclosure, the network device indicates the relevant information of the receive beam to the terminal, so that the terminal can use the corresponding receive beam to receive the data/signal sent by the network device, thereby improving the communication efficiency. In addition, the reference signal overhead caused by beam prediction can be reduced.

In an implementation, the reference signal identifier includes at least one of: a synchronization signal block (SSB) identifier, a channel state information-reference signal (CSI-RS) identifier, or a sounding reference signal (SRS) identifier.

The present disclosure provides a variety of different reference signal identifier types to be applicable to different reference signal scenarios. Accordingly, in the corresponding scenario, the network device can indicate the relevant information of the receive beam to the terminal, and the terminal can use the corresponding receive beam to receive the data/signal sent by the network device, thereby improving the communication efficiency. In addition, the reference signal overhead caused by beam prediction can be reduced.

In an implementation, the beam indication information is transmission configuration indication (TCI) state configuration information and/or spatial relationship configuration information.

In the present disclosure, the network device can indicate the relevant information of the receive beam to the terminal through various types of beam indication information, and the terminal can use the corresponding receive beam to receive the data/signal sent by the network device, thereby improving the communication efficiency. In addition, the reference signal overhead caused by beam prediction can be reduced.

In an embodiment, the apparatus 200 further includes: a sending module 202, configured to send receive beam information of at least one candidate receive beam to the network device, and the receive beam information of the at least one candidate receive beam is carried in at least one of: a data sample for beam prediction model training; a beam report for an input of a beam prediction model; auxiliary information related to the beam prediction model; data for beam prediction model monitoring; or a data sample for beam prediction model fine-tuning.

In the present disclosure, the terminal can send the receive beam information of the at least one candidate receive beam to the network device, so that the network device determines the target receive beam based on the receive beam information of the candidate receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

In an implementation, the receive beam information includes at least one of: a receive beam identifier; a receive beam boresight direction; a receive beam angle; a receive beam width; a receive beam shape; or a receive beam codebook type.

The present disclosure provides a variety of information that can be included in the receive beam, so that the network device indicates the relevant information of the receive beam to the terminal, and the terminal can use the corresponding receive beam to receive the data/signal sent by the network device, thereby improving the communication efficiency. In addition, the reference signal overhead caused by beam prediction can be reduced.

In an implementation, in response to the beam prediction model running on the network device, the target receive beam is determined by the network device based on the beam prediction model.

In the present disclosure, the network device can determine the target receive beam through the beam prediction model, and the network device indicates the relevant information of the target receive beam to the terminal, the terminal can use the target receive beam to receive the data/signal sent by the network device, thereby improving the communication efficiency. In addition, the reference signal overhead caused by beam prediction can be reduced.

In an implementation, the receive beam information of the at least one candidate receive beam is carried by at least one of: a radio resource control (RRC) signaling, a medium access control control element (MAC CE) signaling or uplink control information (UCI).

The present disclosure provides a variety of ways to carry the receive beam information of the candidate receive beam, so that the terminal can send the receive beam information of the candidate receive beam to the network device. Accordingly, the network device determines the target receive beam based on the receive beam information of the candidate receive beam, and the terminal can use the target receive beam to receive the data/signal sent by the network device, thereby improving the communication efficiency. In addition, the reference signal overhead caused by beam prediction can be reduced.

In an implementation, the at least one candidate receive beam includes the target receive beam.

In the present disclosure, the at least one candidate receive beam determined by the terminal may include the target receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

FIG. 8 shows a schematic diagram of another apparatus for indicating a beam according to an embodiment of the present disclosure. Referring to FIG. 8, the apparatus 300 is configured in a network device, and the apparatus 300 may include: a sending module 301, configured to send beam indication information to a terminal; wherein the beam indication information includes a quasico-location (QCL) type D, and the QCL type D is configured to indicate at least one of: a reference signal identifier; or receive beam information of a target receive beam.

In the present disclosure, the network device indicates the relevant information of the receive beam to the terminal, so that the terminal can use the corresponding receive beam to receive the data/signal sent by the network device, thereby improving the communication efficiency. In addition, the reference signal overhead caused by the beam prediction can be reduced.

In an implementation, the reference signal identifier includes at least one of: a synchronization signal block (SSB) identifier, a channel state information-reference signal (CSI-RS) identifier, or a sounding reference signal (SRS) identifier.

The present disclosure provides a variety of different reference signal identifier types to be applicable to different reference signal scenarios. Accordingly, in the corresponding scenario, the network device can indicate the relevant information of the receive beam to the terminal, and the terminal can use the corresponding receive beam to receive the data/signal sent by the network device, thereby improving the communication efficiency. In addition, the reference signal overhead caused by beam prediction can be reduced.

In an implementation, the beam indication information is transmission configuration indication (TCI) state configuration information and/or spatial relationship configuration information.

In the present disclosure, the network device can indicate the relevant information of the receive beam to the terminal through various types of beam indication information, and the terminal can use the corresponding receive beam to receive the data/signal sent by the network device, thereby improving the communication efficiency. In addition, the reference signal overhead caused by beam prediction can be reduced.

In an implementation, the apparatus 300 further includes: a receiving module 302, configured to receive receive beam information of at least one candidate receive beam sent by the terminal, and the receive beam information of the at least one candidate receive beam is carried in at least one of: a data sample for beam prediction model training; a beam report for an input of a beam prediction model; auxiliary information related to the beam prediction model; data for beam prediction model monitoring; or a data sample for beam prediction model fine-tuning.

In the present disclosure, the network device can receive the receive beam information of the at least one candidate receive beam sent by the terminal, so that the network device can determine the target receive beam based on the receive beam information of the candidate receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

In an implementation, the receive beam information includes at least one of: a receive beam identifier; a receive beam boresight direction; a receive beam angle; a receive beam width; a receive beam shape; or a receive beam codebook type.

The present disclosure provides a variety of information that can be included in the receive beam, so that the network device indicates the relevant information of the receive beam to the terminal, and the terminal can use the corresponding receive beam to receive the data/signal sent by the network device, thereby improving the communication efficiency. In addition, the reference signal overhead caused by beam prediction can be reduced.

In an implementation, the apparatus 300 further includes: a processing module 303, configured to, in response to the beam prediction model running on the network device, determine the target receive beam based on the beam prediction model.

In the present disclosure, the network device can determine the target receive beam through the beam prediction model, and the network device indicates the relevant information of the target receive beam to the terminal, the terminal can use the target receive beam to receive the data/signal sent by the network device, thereby improving the communication efficiency. In addition, the reference signal overhead caused by beam prediction can be reduced.

In an implementation, the receive beam information of the at least one candidate receive beam is carried by at least one of: a radio resource control (RRC) signaling, a medium access control control element (MAC CE) signaling or uplink control information (UCI).

The present disclosure provides a variety of ways to carry the receive beam information of the candidate receive beam, so that the terminal can send the receive beam information of the candidate receive beam to the network device. Accordingly, the network device determines the target receive beam based on the receive beam information of the candidate receive beam, and the terminal can use the target receive beam to receive the data/signal sent by the network device, thereby improving the communication efficiency. In addition, the reference signal overhead caused by beam prediction can be reduced.

In an implementation, the at least one candidate receive beam includes the target receive beam.

In the present disclosure, the at least one candidate receive beam determined by the terminal may include the target receive beam. The network device indicates the relevant information of the target receive beam to the terminal, and the terminal can use the target receive beam to receive the data/signal sent by the network device, thereby improving the communication efficiency. In addition, the reference signal overhead caused by beam prediction can be reduced.

Regarding the apparatus in the above embodiments, a specific manner in which each module performs operations has been described in detail in the method embodiments, which will not be elaborated here.

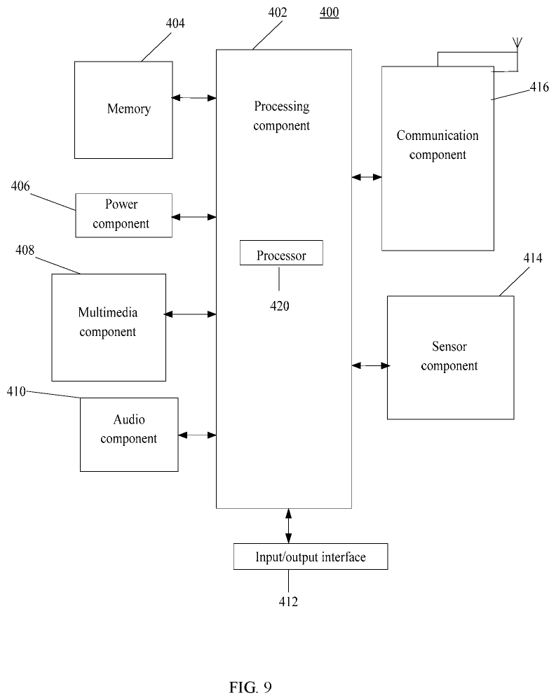

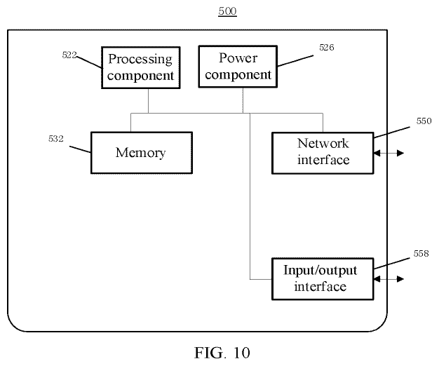

FIG. 9 shows a schematic diagram of a device for indicating a beam according to an embodiment of the present disclosure. For example, the device 400 may be any terminal such as a mobile phone, a computer, a digital broadcast terminal, a messaging device, a gaming console, a tablet device, a medical device, an exercise device, a personal digital assistant, etc.

Referring to FIG. 9, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to complete all or part of the steps in the above described methods. Moreover, the processing component 402 may include one or more modules which facilitate the interaction between the processing component 402 and other components. For example, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 408 includes a front camera and/or a rear camera. The front camera and the rear camera may receive an external multimedia datum while the device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone (MIC) configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide state assessments of various aspects of the device 400. For example, the sensor component 414 may detect an open/closed state of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the device 400 and other devices. The device 400 may access a wireless network based on a communication standard, such as Wi-Fi, 2G or 3G, or a combination thereof. In an embodiment, the communication component 416 receives a broadcast signal or broadcast associated information from an external broadcast management system via a broadcast channel. In an embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the device 400 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 404 including instructions, the above instructions may be executed by the processor 420 in the device 400 for completing the above-described methods. For example, the non-transitory computer-readable storage medium may be a ROM, a Random Access Memory (RAM), a CD-ROM, a magnetic tape, a floppy disc, an optical data storage device, and the like.

FIG. 10 shows a schematic diagram of another device for indicating a beam according to an embodiment of the present disclosure. For example, the device 500 may be provided as a base station or a server. Referring to FIG. 10, the device 500 includes a processing component 522, which further includes one or more processors and a memory resource represented by a memory 532 for storing instructions executable by the processing component 522, such as an application program. The application program stored in the memory 532 may include one or more modules, each corresponding to a set of instructions. In addition, the processing component 522 is configured to execute the instructions to execute the aforementioned method.

The device 500 may further include: a power component 526 configured to perform power management of the device 500, a wired or wireless network interface 550 configured to connect the device 500 to the network, and an input/output (I/O) interface 558. The device 500 may operate an operating system stored in the memory 532, such as Windows Server™, Mac OS X™, Unix™, Linux™, FreeBSD™, or the like.

In the present disclosure, the network device indicates the relevant information of the receive beam to the terminal, so that the terminal can use the corresponding receive beam to receive the reference signal sent by the network device, thereby improving the communication efficiency. In addition, the reference signal overhead caused by beam prediction can be reduced.

It can be further understood that in the present disclosure, “a plurality” refers to two or more, and other quantifiers are analogous to it. “and/or” is used to describe an associated relationship between associated objects and means three relationships, for instance, A and/or B may mean A alone, A and B together, and B alone. The character “/” generally indicates that the associated objects are in an “or” relationship. Singular forms “a”, “an” and “the” are intended to include plural forms as well, unless the context clearly indicates otherwise.

It can be further understood that the terms “first”, “second”, etc. are used to describe various information, but the information should not be limited by these terms. These terms are merely used to distinguish the same type of information from each other and do not denote a particular order or degree of importance. Indeed, the expressions “first”, “second”, etc. may be used interchangeably. For instance, first information may also be referred to as second information, and similarly, second information may also be referred to as first information, without departing from the scope of the present disclosure.

It can be further understood the meanings of the words “in response to” and “if” involved in the present disclosure depend on the context and the actual usage scenario. For example, the word “in response to” as used herein can be interpreted as “upon” or “when” or “if” or “in case”.

It can be further understood that although the operations in embodiments of the present disclosure are described in a specific order in the drawings, they should not be understood as requiring that the operations are performed in the specific order shown or in a serial order, or that all the operations shown are performed to get the desired result. In certain environments, multitasking and parallel processing may be advantageous.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for indicating a beam, performed by a terminal, and comprising:
receiving beam indication information sent by a network device,
wherein the beam indication information comprises a quasico-location (QCL) type D, and the QCL type D is configured to indicate at least one of:
a reference signal identifier; or
receive beam information of a target receive beam.

2. The method according to claim 1, wherein the reference signal identifier comprises at least one of:
a synchronization signal block (SSB) identifier;
a channel state information-reference signal (CSI-RS) identifier; or
a sounding reference signal (SRS) identifier.

3. The method according to claim 1, wherein the beam indication information is at least one of transmission configuration indication (TCI) state configuration information or spatial relationship configuration information.

4. The method according to claim 1, wherein the method further comprises:
sending receive beam information of at least one candidate receive beam to the network device, wherein the receive beam information of the at least one candidate receive beam is carried in at least one of:
a data sample for beam prediction model training;
a beam report for an input of a beam prediction model;
auxiliary information related to the beam prediction model;
data for beam prediction model monitoring; or
a data sample for beam prediction model fine-tuning.

5. The method according to claim 1, wherein the receive beam information comprises at least one of:
a receive beam identifier;
a receive beam boresight direction;
a receive beam angle;
a receive beam width;
a receive beam shape; or
a receive beam codebook type.

6. The method according to claim 1, wherein in response to a beam prediction model running on the network device, the target receive beam is determined by the network device based on the beam prediction model.

7. The method according to claim 4, wherein the receive beam information of the at least one candidate receive beam is carried by at least one of:
a radio resource control (RRC) signaling;
a medium access control control element (MAC CE) signaling; or
uplink control information (UCI).

8. The method according to claim 4, wherein the at least one candidate receive beam comprises the target receive beam.

9. A method for indicating a beam, performed by a network device, and comprising:
sending beam indication information to a terminal,
wherein the beam indication information comprises a quasico-location (QCL) type D, and the QCL type D is configured to indicate at least one of:
a reference signal identifier; or
receive beam information of a target receive beam.

10. The method according to claim 9, wherein the reference signal identifier comprises at least one of:
a synchronization signal block (SSB) identifier;
a channel state information-reference signal (CSI-RS) identifier; or
a sounding reference signal (SRS) identifier.

11. The method according to claim 9, wherein the beam indication information is at least one of transmission configuration indication (TCI) state configuration information or spatial relationship configuration information.

12. The method according to claim 9, wherein the method further comprises:
receiving receive beam information of at least one candidate receive beam sent by the terminal, wherein the receive beam information of the at least one candidate receive beam is carried in at least one of:
a data sample for beam prediction model training;
a beam report for an input of a beam prediction model;
auxiliary information related to the beam prediction model;
data for beam prediction model monitoring; or
a data sample for beam prediction model fine-tuning.

13. The method according to claim 9, wherein the receive beam information comprises at least one of:
a receive beam identifier;
a receive beam boresight direction;
a receive beam angle;
a receive beam width;
a receive beam shape; or
a receive beam codebook type.

14. The method according to claim 9, wherein the method further comprises:
in response to a beam prediction model running on the network device, determining the target receive beam based on the beam prediction model.

15. The method according to claim 12, wherein the receive beam information of the at least one candidate receive beam is carried by at least one of:
a radio resource control (RRC) signaling;
a medium access control control element (MAC CE) signaling; or
uplink control information (UCI).

16. The method according to claim 12, wherein the at least one candidate receive beam comprises the target receive beam.

17-18. (canceled)

19. A terminal device, comprising:
a processor; and
a memory, configured to store executable instructions of the processor;
wherein the processor is configured to:
receive beam indication information sent by a network device,
wherein the beam indication information comprises a quasico-location (QCL) type D, and the QCL type D is configured to indicate at least one of:
a reference signal identifier; or
receive beam information of a target receive beam.

20. A network device, comprising:
a processor; and
a memory, configured to store executable instructions of the processor;
wherein the processor is configured to execute the method according to claim 9.

21. A non-transitory computer-readable storage medium, wherein instructions in the storage medium, when executed by a processor of a terminal, enables the terminal to perform the method according to claim 1.

22. A non-transitory computer-readable storage medium, wherein instructions in the storage medium, when executed by a processor of a network device, enables the network device to perform the method according to claim 9.
